(19) United States
(12) Patent Application Publication
(10) Pub. No.: US 2025/0086410 A1
(43) Pub. Date: Mar. 13, 2025

(54) IMMERSIVE STORYTELLING SLEEP TENT

(71) Applicant: Burble Inc., Riverside, CA (US)

(72) Inventors: Taylor Cole, Crestline, CA (US); Amelia Soriano, Riverside, CA (US); Jeff Greenan, Redlands, CA (US)

(73) Assignee: Burble Inc., Riverside, CA (US)

(21) Appl. No.: 18/883,609

(22) Filed: Sep. 12, 2024

Related U.S. Application Data
(60) Provisional application No. 63/582,483, filed on Sep. 13, 2023.

(51) Int. Cl. G06K 7/10; A47C 29/00; G06F 3/16; G10L 15/22; H04R 1/02; H04R 3/00; H05B 47/155

(52) U.S. Cl. CPC G06K 7/10366; A47C 29/003; G06F 3/165; G06F 3/167; H04R 1/028; H04R 3/00; G10L 15/22; H04R 2420/07; H05B 47/155

(57) ABSTRACT

A method for providing an immersive storytelling experience within an enclosure. The method includes identifying, by a controller, a selected story. The method further includes retrieving, by the controller, a specific environment associated with the selected story, the specific environment including lighting information and audio information each corresponding to the selected story. The method further includes controlling, by the controller, a plurality of light sources within the enclosure to output the retrieved lighting information corresponding to the selected story. The method further includes controlling, by the controller, at least one speaker to output the retrieved audio information corresponding to the selected story.

### CROSS-REFERENCE TO RELATED APPLICATIONS

This application is a non-provisional U.S. patent application which claims the benefit and priority of U.S. Provisional Application No. 63/582,483, titled IMMERSIVE STORYTELLING SLEEP TENT and filed on Sep. 13, 2023, the entire contents of which being hereby incorporated by reference in its entirety.

### BACKGROUND

### 1. Field

The present disclosure is directed to systems and methods for providing an immersive storytelling experience and, more particularly, to novel enclosures that provide lighting and audio data that supplement storytelling.

### 2. Background

Research suggests that increased effort by an audience member in assembling a narrative increases the permanence of the narrative in that member's mind. Yet, the modern trend has been to provide more and more detail, leaving minimal opportunity for audience creativity beyond passive experience. This is emphasized by the explosion in popularity of televisions, computers, mobile phones, and the like because they provide many details about the narrative and fail to foster any audience creativity.

Thus, there is a need in the art for systems and methods for providing an immersive storytelling experience while providing opportunities for audience creativity.

### SUMMARY

Disclosed herein is a method for providing an immersive storytelling experience within an enclosure. The method includes identifying, by a controller, a selected story. The method further includes retrieving, by the controller, a specific environment associated with the selected story, the specific environment including lighting information and audio information each corresponding to the selected story. The method further includes controlling, by the controller, a plurality of light sources within the enclosure to output the retrieved lighting information corresponding to the selected story. The method further includes controlling, by the controller, at least one speaker to output the retrieved audio information corresponding to the selected story.

Also disclosed is a method for providing an immersive storytelling experience within an enclosure. The method includes identifying, by a controller, a selected story. The method further includes retrieving, by the controller, a specific environment associated with the selected story, the specific environment including lighting information corresponding to light output that visually represents features of text of the selected story and audio information including sound effects corresponding to the selected story. The method further includes controlling, by the controller, a plurality of light sources within the enclosure to output the retrieved lighting information such that timing of the light that is output by the plurality of light sources is temporally aligned with timing of the text of the selected story. The method further includes controlling, by the controller, at least one speaker to output the retrieved audio information corresponding to the selected story such that timing of the sound effects is temporally aligned with the timing of the text of the selected story.

Also disclosed is a method for providing an immersive storytelling experience within an enclosure. The method includes detecting, by a radio frequency identification (RFID) reader, a RFID tag associated with a selected story in response to the RFID tag being located in or near the enclosure. The method further includes identifying, by a controller, the selected story in response to the detecting of the RFID tag. The method further includes retrieving, by the controller, a specific environment associated with the selected story, the specific environment including lighting information corresponding to light output that visually represents features of text of the selected story and audio information including a spoken version of the text of the selected story and sound effects corresponding to the selected story. The method further includes controlling, by the controller, a plurality of light sources within the enclosure to output the retrieved lighting information such that timing of the light that is output by the plurality of light sources is temporally aligned with timing of the spoken version of the text of the selected story. The method further includes controlling, by the controller, at least one speaker to output the retrieved audio information corresponding to the selected story such that timing of the sound effects is temporally aligned with the timing of the spoken version of the text of the selected story.

### BRIEF DESCRIPTION OF THE DRAWINGS

Other systems, methods, features, and advantages of the present disclosure will be or will become apparent to one of ordinary skill in the art upon examination of the following figures and detailed description. It is intended that all such additional systems, methods, features, and advantages be included within this description, be within the scope of the present disclosure, and be protected by the accompanying claims. Component parts shown in the drawings are not necessarily to scale, and may be exaggerated to better illustrate the important features of the present disclosure. In the drawings, like reference numerals designate like parts throughout the different views, wherein:

FIG. 1A is a drawing illustrating a perspective view of a system for providing an immersive storytelling experience, in accordance with various embodiments of the present disclosure;

FIG. 1B is a front view of the system of FIG. 1A, in accordance with various embodiments of the present disclosure;

FIG. 1C is a block diagram illustrating various components of the system of FIG. 1A, in accordance with various embodiments of the present disclosure;

FIG. 2 is a perspective view of the system of FIG. 1A with certain features hidden, in accordance with various embodiments of the present disclosure;

FIG. 3 is a perspective view illustrating features of a frame of the system of FIG. 1A, in accordance with various embodiments of the present disclosure;

FIG. 4 is a perspective view illustrating features of a frame of the system of FIG. 1A, in accordance with various embodiments of the present disclosure;

FIG. 5 is a top-down view of a two layers of a flattened sheet structure of the system of FIG. 1A, in accordance with various embodiments of the present disclosure;

FIG. 6 is side view of features of a sheet structure of the system of FIG. 1A, in accordance with various embodiments of the present disclosure;

FIG. 7 is a front view of features of the system of FIG. 1A, in accordance with various embodiments of the present disclosure.

FIG. 8 is a view of an internal surface of a sheet structure of the system of FIG. 1A, in accordance with various embodiments of the present disclosure;

FIG. 9 is a top-down view showing placement of light sources within the system of FIG. 1A, in accordance with various embodiments of the present disclosure;

FIG. 10 is a flowchart illustrating a method for providing an immersive storytelling experience using a system similar to the system of FIG. 1A, in accordance with various embodiments of the present disclosure; and

FIG. 11 is a flowchart illustrating a method for providing an immersive storytelling experience using a system similar to the system of FIG. 1A, in accordance with various embodiments of the present disclosure.

### DETAILED DESCRIPTION

The present disclosure describes systems and methods for defining and presenting narratives or stories. The systems and methods are designed to capture attention of the user, cause the user to become more engaged in the storytelling process, and to present opportunities for the user to be creative during the story. Studies have shown that engaged creativity increases user recall of the subject matter of the narrative or story. In addition, increased engagement and creativity by a user with characteristics that are on the autism spectrum provides measurable benefits to the autistic user. These benefits include a calming effect on the user, which allows the user to settle into deep, restful sleep.

An exemplary system includes a structure that defines a volume for receiving at least a head of a user. The structure is designed to be coupled to a bed such that a user may lay in bed while experiencing a story or narrative. The system further includes a plurality of light sources positioned within the structure which generate light that at least partially illuminates the volume. The structure is designed to block at least some light from entering the volume of the structure, thus allowing the illumination from the internal light sources to become prominent. The system further includes a controller that is coupled to the plurality of light sources. The controller may be located in the structure or may be included in a mobile device (e.g., smartphone) that communicates with elements within the structure. The controller is designed to identify a current location within a story and to control the plurality of light sources to illuminate in a way that visually represents something at the current location within the story. For example, the light sources may flash red while a protagonist is supposed to be angry, and may output a constant blue light during times of calm. This suggestive lighting causes the user to become more engaged in the story, and further provides opportunities for the user to use his mind creatively. In some embodiments, the system may include or be coupled to a speaker that is electrically coupled to the controller. The controller may identify a story to be told, may control the speaker to output a spoken version of the story, and may control the lights to illuminate based on an atmosphere, event, mood, or other literary element at the current sentence or section of the story.

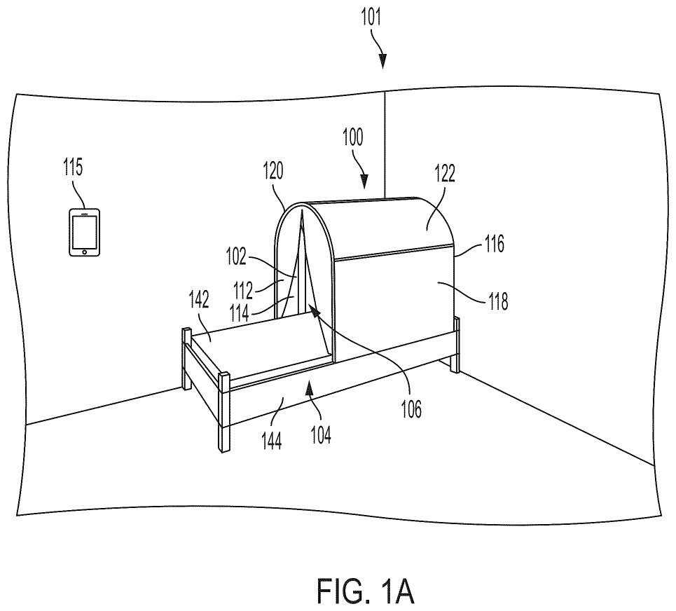

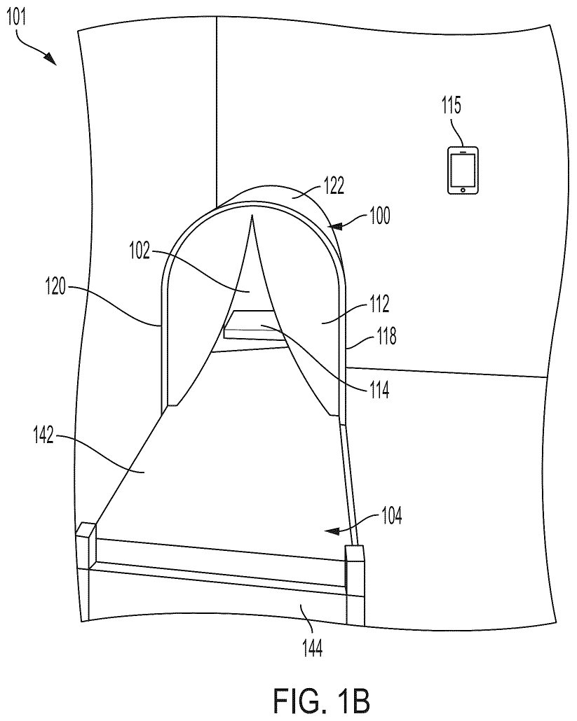

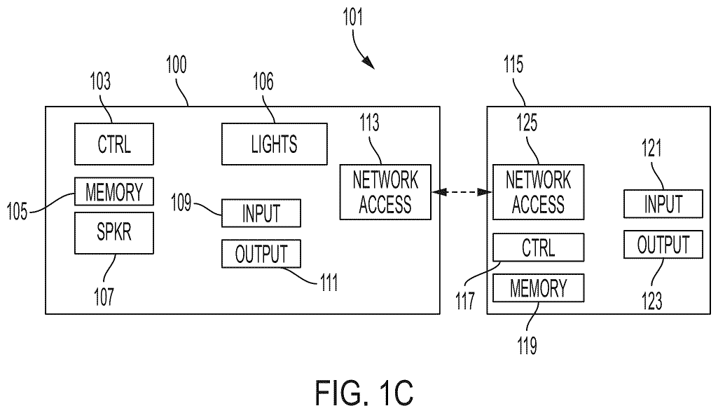

Referring to FIGS. 1A and 1B, a system 101 for defining and presenting a narrative, or for immersive storytelling, is shown. The system 101 may include a structure, or enclosure, 100 that defines a volume 102. The structure 100 may be designed to be coupled to an object, such as a bed 104. In some embodiments, the structure 100 may be free-standing or may be designed to be coupled to objects other than (or in addition to) beds such as a chair, a recliner, a couch, an exercise mat, a floor mat, or any other object. The system 101 may also include, or be coupled to, a mobile device 115 that communicates with one or more element within the enclosure 100. The mobile device 115 may include, for example, a smartphone, a tablet, a laptop computer, a desktop computer, or the like.

The system 101 may include a plurality of light sources 106 positioned within the volume 102 that are designed to be controlled to at least partially illuminate the inside of the volume 102. That is, the light sources 106 may illuminate an inner surface of the structure 100 that faces the volume 102. The structure 100 may define an opening 114 through which at least a portion of a human (e.g., a human head) may enter the volume 102. For example, a human may lay down on the bed 104 with his or her head (or head and at least a portion of his or her torso) extending through the opening 114 into the volume 102. In some embodiments, a sheet structure (e.g., fabric or another material) may at least partially surround a portion of the human to further enclose the human head within the volume 102. The structure 100 may block at least some light that is external relative to the volume 102 from reaching the volume 102. That is, the structure may reduce an amount of outside light that illuminates the volume 102, and may similarly reduce an amount of light from the light sources 106 that exits the volume 102. In that regard, a user with his or her head in the volume 102 may be exposed to a relatively great amount of light that is generated by the light sources 106 and exposed to a reduced amount of light originating from outside of the volume 102.

Referring to FIGS. 1A-1C, the system 101 may include a controller 103, a non-transitory memory 105, the lights 106, a speaker 107, an input device 109, an output device 111, and a network access device 113 all coupled to or located within the enclosure 100. The controller 103 may be coupled to each of the lights 106, the speaker 107, the input device 109, the output device 111, and the network access device 113. In some embodiments, the system 101 may further include a mobile device 115 which may include a controller 117, a memory 119, an input device 121, an output device 123, and a network access device 125. In some embodiments, the mobile device 115 may include any user device capable of electronic communications such as a smartphone, a tablet, a laptop, a desktop, or the like. The mobile device 115 may be provided by the user and may download and run a mobile application. In some embodiments, the mobile device may be provided as part of the system 101.

The memory 105 may include any non-transitory memory such as a solid-state memory, random access memory (RAM), read only memory (ROM), an internal or external hard drive, a removable memory stick, or any additional or alternative digital or analog memory device capable of storing data. As used herein, the term “non-transitory” is to be understood to remove only propagating transitory signals per se from the claim scope and does not relinquish rights to all standard computer-readable media that are not only propagating transitory signals per se. The memory 105 may, for example, store instructions usable by the controller 103 to perform operations as discussed herein. The memory 105 may also or instead store any data as requested by the controller 103. The memory 105 may also or instead store story data corresponding to one or more story for which the system 101 is designed to output data. For example, the memory 105 may store speech audio data corresponding to text of a story. The memory 105 may also store audio data designed to be output by the speaker 107 and corresponding to various environments or atmospheres (as will be discussed further below), and light data designed to be output by the lights 106 and corresponding to various environments or atmospheres (as will also be discussed further below). Any discussion of the memory 105 may also apply to the memory 119.

The controller 103 may include any one or more controller or processor capable of performing logic functions. For example, the controller 103 may include a general purpose processor, a digital signal processor, an application specific integrated circuit (ASIC), a field programmable gate array (FPGA) or other programmable logic device, discrete gate or transistor logic, discrete hardware components, or any combination thereof. The processor may be configured to implement various logical operations in response to execution of instructions, for example, instructions stored on a tangible non-transitory memory (e.g., the memory 105 or a separate dedicated or non-dedicated non-transitory memory) or computer-readable medium. Any discussion of the controller 103 may also apply to the controller 117. In some embodiments, the mobile device 115 may download and run a mobile application to cause the controller 117 to function with the system 101 as desired.

The plurality of light sources 106 may be distributed within the volume 102. For example, the plurality of light sources 106 may include light emitting diodes (LEDs). In some embodiments, the light sources 106 may include multiple strips of LEDs positioned within the volume 102. In some embodiments, the light sources 106 may include light sources other than LEDs (e.g., incandescent light bulbs). In some embodiments, each of the lights 106 may be controlled (i.e., by the controller 103) to output light of different colors, to output light of different intensities (i.e., may be controlled to vary a quantity of lumens generated by each of the lights 106), and to turn on or off in different patterns or at different times. In that regard, each light source of the plurality of light sources 106 may be controlled independently from the remaining light sources. The light sources 106 may be controlled in one or more of these manners in order to simulate different environments or atmospheres within the volume 102. For example, if a desired environment or atmosphere is angry then the controller 103 may control the light sources 106 to output a bright red light and to flash on and off relatively quickly; if a desired environment or atmosphere is calm then the controller 103 may control the light sources 106 to output a steady blue light.

The speaker 107 may include any one or more speaker of any type that is capable of outputting audio data. In some embodiments, the system 101 may lack a speaker and may simply include a wired or wireless connection or port to which a speaker may be logically and/or physically coupled. The controller 103 may be logically coupled to the speaker 107 (or the connection to which the speaker may be attached) and be capable of controlling the operation of the speaker 107. The speaker 107 may be controlled to output a variety of audio data such as spoken language, sound effects (e.g., applause, thunder, suspenseful music, etc.), and may output multiple types of audio data simultaneously (e.g., may output spoken language simultaneously with the sound of rain). In some embodiments, the controller 103 may control the speaker 107 to output speech data that corresponds to a story to be read by a user of the system 101. The controller 103 may simultaneously control the speaker 107 and the light sources 106 to vary an environment or atmosphere within the enclosure 100 based on an environment or atmosphere at a location within a present story which is being read at that time. For example, while the speaker 107 is outputting speech data corresponding to a suspenseful part of a story, the light sources may flash rapidly and the speaker 107 may simultaneously output suspenseful music to increase the suspenseful atmosphere within the enclosure 100. In some embodiments, the speaker 107 may output audio data to generate or enhance an atmosphere without also outputting speech data. In some embodiments, the speaker 107 may only output speech data without also outputting additional audio data related to a desired atmosphere. In some embodiments, the output device 123 of the mobile device 115 may include a speaker. In that regard, the speaker of the mobile device 115 may function in a similar manner as the speaker 107. In some embodiments, the enclosure 100 may lack a speaker 107 and the output device 123 of the mobile device 115 may function as the speaker 107 of the enclosure 100.

The input device 109 may be logically coupled to the controller 103 and may include any input device capable of receiving input data. For example, the input device 109 may include any one or more of a keyboard, a mouse, a touchscreen, a microphone, a radio frequency identification (RFID) reader, or any other input device that is capable of receiving user input. In that regard, a user may provide data to the system 101 (and the controller 103) using the input device 109. For example, a user may use the input device to inform the controller 103 that a certain book or story will be read. For example, the user may use a keyboard, mouse, or touchscreen to input a story name or select a story from a list of stories. As another example, a book may include an RFID chip that is automatically detected by the input device 109 (i.e., if the input device 109 includes an RFID reader) as the book is brought near the enclosure 100 or within the volume 102. As yet another example, a user may insert a CD or a universal serial bus (USB) stick into a CD-ROM port or USB port (such that the CD-ROM or USB port is the input device 109). A user may also provide user input indicating a desired start time at which the story will be read. For example, a user may click a button within the enclosure 100 to indicate that it is time to start reading the story. In some embodiments, the controller 103 may determine a start time for the story based on trigger data such as a button press by the user, a spoken command from the user, detection of a RFID tag in a certain location, or any other trigger data.

As suggested above, in some embodiments, the controller 103 may control the speaker 107 to output speech data that corresponds to a reading of the story, and may simultaneously control the lights 106 to output light data and the speaker 107 to output audio data to set an atmosphere based on a current location within the story. In some embodiments, the controller 103 may control the lights to output light data and the speaker 107 to output audio data to set an atmosphere based on a current location within the story without outputting speech data. In such embodiments, the intention may be for the light data and audio data to be output while a user is reading the story to him or herself. In some embodiments, the user may request a pause in progression of the story to cause the controller 103 to pause output by the speaker 107 and by the lights 106 for a period of time (or until a request to continue is received).

In some embodiments, the input device 109 may include a microphone designed to detect audio data corresponding to speech of a user. In these embodiments, the controller 103 may determine a current location within a story based on user speech data. For example, the controller 103 may identify a specific location in a story that is being read aloud by a user based on detected words spoken by the user. That is, the controller 103 may detect a string of words that has been spoken by the user based on the detected audio data and may compare the string of words to words within the story to determine a specific location that is being read within the story. In such embodiments, the controller 103 may control the lights 106 and speaker 107 to generate atmosphere-creating light and audio data based on the detected location within the story.

The output device 111 may be logically coupled to the controller 103 and may include any one or more output device such as a display, a touchscreen, one or more additional light, one or more additional speaker, or the like. In some embodiments, at least one or more lights 106 or the speaker 107 may function as an output device (in addition to, or instead of, the output device 111). The output device 111 may output any output data to be provided to a user of the system 101. For example, the output device 111 may output a list of stories which may be selected by a user, may output a status of the system 101, may output troubleshooting data, may output network connection data, or may output any additional or alternative data.

The network access device 113 may be logically coupled to the controller 103 and may include any network access device (e.g., a port, a chipset, a connector, or the like) capable of communicating with a remote device via a wired or wireless connection. For example, the network access device may be designed to communicate via Wi-Fi, Bluetooth®, Ethernet, universal serial bus (USB), or any additional or alternative protocol or connection type. In some embodiments, the network access device 113 may include multiple network access devices. For example, the network access device 113 may include a first Bluetooth® antenna or receiver (e.g., a Bluetooth® low energy, or BLE, receiver) that is coupled to the plurality of lights 106 and a second Bluetooth® antenna or receiver that is coupled to the speaker 107. In that regard, the mobile device 115 may be capable of controlling the lights 106 and the speaker 107 via the network access devices 125, 113. As another example, the network access device 113 may include a Bluetooth® antenna or receiver coupled to the plurality of lights 106 and the speaker 107 and a Wi-Fi port that may communicate with the controller 103 and remote devices (e.g., the mobile device 115) and communicate therebetween. In some embodiments, the Wi-Fi port may be coupled to the lights 106 and speaker 107 (e.g., directly coupled to or via coupling with the controller 103) such that Wi-Fi signals may be used to control the lights 106 and speaker 107.

The network access device 113 may, for example, communicate with a remote server. The remote server may store audio data and light data corresponding to one or more story for which the system 101 is designed to output audio and light data. In that regard, the controller 103 may retrieve the audio data and the light data from the remote server via the network access device 113 and may control the speaker 107 and lights 106 to output the audio and light data, respectively. In some embodiments, the controller 103 may be designed to control the network access device 113 to retrieve audio and light data from the remote server for new stories as they become available, and may control the memory 105 to store the new audio and light data. In some embodiments, the network access device 113 may be designed to communicate with a user device (e.g., a smartphone) 115. In such embodiments, the user device 115 may function as at least one of an input device or an output device. For example, the controller 103 may control the network access device 113 to transmit output data to the user device to be output by the user device, and the controller 103 may receive input data from the user device via the network access device 113. In that regard, the user device may operate as a remote controller for the system 101. In some embodiments, the mobile device 115 may function as a controller for the various elements of the system 101, as described more fully below.

In one example of operation, a user may bring a book having an RFID tag into the enclosure 100. An RFID reader may detect the RFID tag and may identify a corresponding story. The controller 103 may determine that corresponding audio and light data is not stored in the memory 105, and may control the network access device 113 to retrieve corresponding audio and light data from a remote server. The controller 103 may then control the speaker 107 and lights 106 to output the retrieved audio and light data, respectively. In some embodiments, the controller 103 may control the speaker 107 and lights 106 to begin outputting data in response to the data being retrieved from the remote server and, in some embodiments, the controller may control the speaker 107 and lights 106 to begin outputting data in response to specific input being received from the user.

The input device 121 of the mobile device 115 may include any mobile device included with, or coupled to, the mobile device 115. For example, the input device 121 may include at least one of a touchscreen, a keyboard, a microphone, a mouse, or the like. The output device 123 of the mobile device 115 may include, for example, a touchscreen, a display, a speaker, or the like.

The network access device 125 of the mobile device 115 may be logically coupled to the controller 117 and may include any network access device (e.g., a port, a chipset, a connector, or the like) capable of communicating with a remote device via a wired or wireless connection. For example, the network access device 125 may be designed to communicate via Wi-Fi, Bluetooth®, Ethernet, universal serial bus (USB), or any additional or alternative protocol or connection type. In that regard, the mobile device 115 may communicate with various elements of the enclosure 100 via the network access device 125 of the mobile device 115 and the network access device 113 of the enclosure 100. The network access device 125 may communicate via any one or more protocol (e.g., via Bluetooth® and Wi-Fi).

In embodiments in which the mobile device 115 is utilized with the system 101, the enclosure 100 may lack a controller. In that regard, the controller 117 of the mobile device 115 may communicate with one or more element of the enclosure 100 via the network access device 125 of the mobile device and the network access device 113 of the enclosure 100 such that functions of the controller 103 are performed by the controller 117 of the mobile device 115.

In another example of operation, a user may use the input device 121 of the mobile device 115 to identify a book that will be read in the enclosure 100. The controller 117 may access corresponding audio and light data in the memory 119. If the audio and light data are not stored in the memory 119, the controller 117 may control the network access device 125 to retrieve corresponding audio and light data from a remote server. The controller 117 may then remotely control the speaker 107 and lights 106 to output the corresponding audio and light data, respectively, via the network access device 125 of the mobile device and one or more network access device 113 that is coupled to the lights 106 and speaker 107. In some embodiments, the output device 123 may include a speaker, and the controller 117 may control the speaker of the output device 123 to output the audio data (instead of, or in addition to, the speaker 107 of the enclosure 100). The user may use the input device to change stories that are being read, to pause in the middle of a reading, to fast forward or rewind a portion of a reading, to start or restart a reading, or the like. In some embodiments, the input device 121 of the mobile device 115 may include a microphone such that the controller 117 determines a location in the story based on speech data of the user that is detected by the microphone, and controls the lights 106 and speaker 107 to output light and audio data based on the determined location in the story.

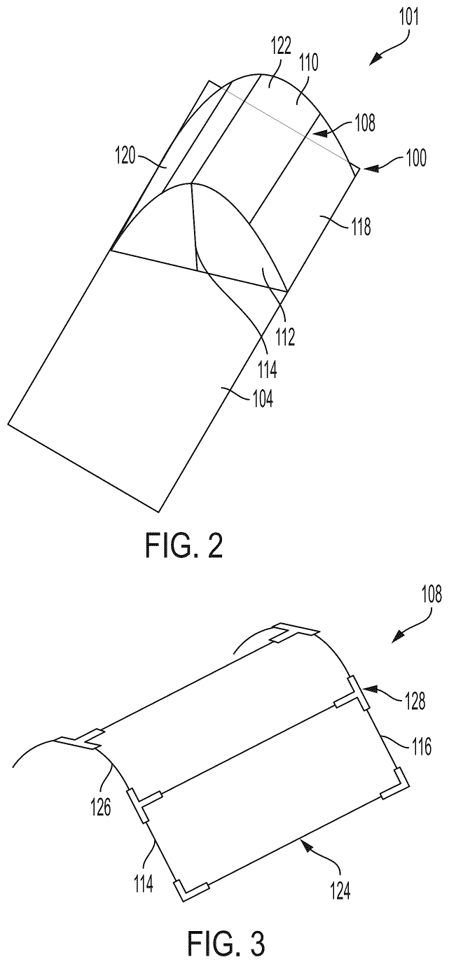

Referring to FIGS. 1A, 1B, 2, 3, and 4, the enclosure 100 may include a frame 108 that forms a shape of the enclosure 100 and supports various features of the enclosure 100. The enclosure 100 may also include a flexible or pliant sheet structure, or sheet, 110 (which may include a composite or combination of multiple layers or materials). The frame 108 may support the sheet 110, and the sheet 110 may cover gaps within the frame 108.

The enclosure 100 may include (and the frame 108 and sheet 110 may define) a first end 112 that defines an opening 114. The opening 114 may define a location through which a user may insert his or her head into the enclosure 100. In some embodiments, the opening 114 may include a loose portion of the sheet which a user may push aside to enter the enclosure 100 and which may surround at least a portion of the user that is located within the opening 114 in response to the loose sheet no longer being pushed aside. Alternative designs are also contemplated for the opening 114 such as buttons or snaps used to keep a portion of the sheet away from the opening 114, a zipper door, or any other design that allows entry of a portion of a human and at least partially seals the portion of the human within the volume 102.

The enclosure 100 may further include a second end 116 that is opposite the first end 112. The second end 116 may include a solid piece of the sheet 110 to seal the volume 102 from an area external relative to the volume. The enclosure 100 may further include a first sidewall 118 extending from the first end 112 to the second end 116 and forming a first side of the enclosure 100; the enclosure may also include a second sidewall 120 opposite the first sidewall 118, extending parallel to the first sidewall 118, also extending from the first end 112 to the second end 116, and forming a second side of the enclosure 100. In some embodiments, the sidewalls 118, 120 may extend parallel to a length of the bed 104 from a foot of the bed 104 to a head of the bed 104. An arched top 122 may extend from the first sidewall 118 to the second sidewall 120. In some embodiments, the arched top 122 may be considered to be an extension of the sidewalls 118, 120. In some embodiments, the sidewalls 118, 120 may have a straight vertical portion before the arched top 122 and, in some embodiments, the sidewalls 118, 120 may have at least a slight curvature throughout their respective heights.

The shape of the enclosure 100 may be defined by the frame 108 and the sheet 110 and, in particular, by the first end 112, the second end 116, the sidewalls 118, 120, and the arched top 122. The sheet 110 may be designed to prevent or reduce light from the light sources 106 from escaping the volume 102, and to prevent or reduce external light from reaching the volume 102. In some embodiments, the sheet 110 may also provide some acoustic benefits such as reducing any auditory echoes, at least partially soundproofing the enclosure 100 to reduce ingress of external audio into the volume 102 and egress of audio from the speaker 107. At least one of the frame 108 or the sheet 110 may house or support various features of the enclosure 100 such as the controller 103, the memory 105, the light sources 106, the speaker 107, the input and output device 109, 111, and the network access device 113. In some embodiments, at least one of these elements may be housed between two or more layers of the sheet 110 to reduce the likelihood of damage to the element and to reduce the likelihood of separation of the element from the enclosure 100. In some embodiments and as discussed further below, the sheet 110 may at least partially enclose elements of the frame 108 to at least one of retain the sheet 110 in place relative to the frame 108 or to reduce exposure of any element of the frame 108 to damage or injury.

The frame 108 may include multiple elongated members that are coupled together to create a structure. In particular, the frame 108 may include a first plurality of elongated members 124 which may substantially extend from the first end 112 to the second end 116, and which extend substantially parallel to the sidewalls 118, 120. The first plurality of elongated members 124 may be spaced apart from each other in a direction extending from the first sidewall 118 to the second sidewall 120. The frame 108 may further include a second plurality of elongated members 126 which may extend from the first sidewall 118 to the second sidewall (and thus potentially across the arched top 122), and which may extend substantially perpendicular to the first plurality of elongated members 124. The second plurality of elongated members 126 may be spaced apart from each other in a direction extending from the first end 112 to the second end 116.

The elongated members 124, 126 may be formed from any one or more material. For example, the elongated members 124, 126 may be formed from a metal or metal alloy (e.g., aluminum, iron, steel, or the like), a plastic material, wood, fiberglass, a material impregnated with carbon fibers, any other material or polymer, or the like. In some embodiments, the elongated members 124, 126 may be flexible or semi-rigid and may bend when coupled together to create tension within the frame 108. In some embodiments, the elongated members 124, 126 may be rigid. In some embodiments, one or more of the elongated members 124, 126 may include multiple portions that couple together to form a longer elongated member (e.g., in a similar manner as segmented tent poles). That is, one or more of the elongated members 124, 126 may be collapsible for easier transport and storage. In such embodiments, the multiple portions of each elongated member may be coupled together (e.g., via an elastic rope) to facilitate easier assembly of the structure 101 such that they remain connected in proper order when disassembled. In some embodiments, the multiple portions of each elongated member may lack connections when disassembled. In some embodiments, each portion of one or more of the elongated members may be the same. In some embodiments, the portions of the elongated members may be labeled to aid in assembly. The portions of the elongated members may connect together in any known manner such as using snap fit connectors, interference fit connections, fasteners, or the like.

In some embodiments, one or more of the first plurality of elongated members 124 and/or one or more of the second plurality of elongated members 126 may include two or more elongated members coupled together to function as a longer elongated member. In some embodiments, one or more of the first plurality of elongated members 124 may be coupled to one or more of the second plurality of elongated members 126. In that regard, the frame 108 may include one or more physical connectors 128 designed to physically couple one or more elongated member to another one or more elongated member. For example and as shown in detail in FIG. 3, the first plurality of elongated members 124 may include single elongated members that extend from the first end 112 to the second end 116. The second plurality of elongated members 126 may include multiple segments that couple together to extend from the first sidewall 118 to the second sidewall 120. A physical connector 128 may couple an elongated member from the first plurality of elongated members 124 to two segments of an elongated member from the second plurality of elongated members 126. In that regard, the enclosure 100 may be assembled by connecting the elongated members 124, 126 together using connectors 128 and by coupling the sheet 110 to the frame 108. The connectors 128 and elongated members 124, 126 may be coupled together using any known means such as snap fit connectors, interference fit connections, fasteners, or the like.

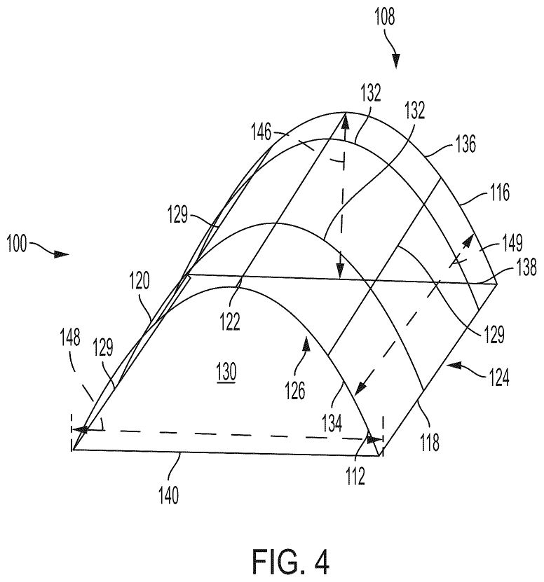

Referring now to FIG. 4, additional details of the frame 108 are provided. In the example shown in FIG. 4, the first plurality of elongated members 124 (i.e., members extending from the first end 112 to the second end 116) may include 5 elongated members. The first plurality of elongated members 124 may include a cross bar 130 located at the top of the frame 108 and extending along the arched top 122. The first plurality of elongated members 124 may also include two side support bars 129 extending parallel to the cross bar 130 from the first end 112 to the second end 116. The side support bars 129 and the cross bar 130 may be spaced apart from each other in a direction spanning from the first sidewall 118 to the second sidewall 120. The outer side support bars 129 (the side support bars 129 that are located farthest from the arched top 122) may be located at a bottom of the enclosure 100 (i.e., at a bottom of the sidewalls 118, 120) and may thus be located adjacent to a bed on which the enclosure 100 is positioned.

In the example shown in FIG. 4, the second plurality of elongated members 126 (i.e., members extending from the first sidewall 118 to the second sidewall 120) may include 4 elongated members. The second plurality of elongated members 126 may include a front support arch 134 located at the first end 112 and extending from the first sidewall 118 to the second sidewall 120. The second plurality of elongated members 126 may also include a rear support arch 136 located at the second end 116 and extending from the first sidewall 118 to the second sidewall 120. The second plurality of elongated members 126 may also include two internal support arches 132 located between the front support arch 134 and the rear support arch 136 between the first end 112 and the second end 116, and also extending from the first sidewall 118 to the second sidewall 120. The front support arch 134, rear support arch 136, and internal support arches 132 may each extend parallel to each other.

In some embodiments, the enclosure 100 may include a back support bar 138 located at the bottom of the enclosure 100 at the second end 116. The back support bar 138 may be considered a part of the frame 108. The back support bar 138 may extend from the bottom side support bar 129 on the first sidewall 118 to the bottom side support bar 129 on the second sidewall 120. Although the back support bar 138 may start and end at the same locations as the rear support arch 136, the back support bar 138 may lack curvature and may extend straight from the bottom of the first sidewall 118 to the bottom of the second sidewall 120. That is, the back support bar 138 may be located along a bottom of the enclosure 100. The back support bar 138 may include similar features as the plurality of elongated members 124, 126 and may be coupled to the elongated members 124, 126 in a similar manner as the elongated members 124, 126 are coupled to each other.

In some embodiments, the enclosure 100 may include a tension strap 140. The tension strap may include any strap of material (e.g., plastic, another polymer, a rope, a cable, a wire, or the like) and may be located at the bottom of the enclosure at the first end 112. The tension strap 140 may extend from the bottom side support bar 129 on the first sidewall 118 to the bottom side support bar 129 on the second sidewall 120. In some embodiments, the tension strap 140 may be removably coupled to at least one of the first sidewall 118 or the second sidewall 120. In that regard and referring to FIGS. 1A, 1B, and 4, the tension strap 140 may be used to couple the enclosure 100 to the bed 104. For example, the tension strap 140 may be disconnected from one or both of the first sidewall 118 and the second sidewall 120 and the enclosure 100 may be positioned at a desired location on the bed 104. The tension strap 140 may then be positioned between a mattress 142 and a bedframe 144 of the bed and may then be coupled to the first sidewall 118 and the second sidewall 120. In that regard, the tension strap 140 may couple the enclosure 100 to the bed 104 and may resist movement of the enclosure 100 relative to the bed 104. The tension strap 140 may then be disconnected from one or both of the sidewalls 118, 120 and removed from under the mattress 142 to disconnect the enclosure 100 from the bed 104.

The back support bar 138 and the tension strap 140 may also assist in retaining the elements of the frame 108 in place relative to each other and may thus operate as additional support for the frame 108. In some embodiments, the tension strap 140 may be replaced with a front support bar (not shown); in some embodiments, the enclosure 100 may include the tension strap 140 and a front support bar; and in some embodiments, the enclosure 100 may lack the tension strap 140 and a front support bar. In some embodiments, the back support bar 138 may be replaced with a rear tension strap (not shown); in some embodiments, the enclosure may include the back support bar 138 and a rear tension strap; and in some embodiments, the enclosure may lack the back support bar 138 and a rear tension strap. In some embodiments, at least one of one or more additional tension straps or one or more additional support bar may be included with the enclosure 100. These additional tension strap(s) or support bar(s) may be located along a length of the enclosure between the first end 112 and the second end 116.

In some embodiments, at least one of the enclosure 100 or various components of the enclosure 100 (e.g., components of the frame 108, the sheet 110, or the like) may have any dimensions. Some dimensions or ranges of dimensions may be preferred for various implementations. For example, one set or range of dimensions may be preferred for a bed-top embodiment of the enclosure 100 and another set or range of dimensions may be preferred for a floor-based standalone embodiment of the enclosure 100. The disclosure will now discuss an exemplary set of dimensions for a bed-top embodiment of the enclosure 100.

In some embodiments, the frame 108 (and thus enclosure 100) may have a height 146. It may be desirable for the height 146 to be sufficiently large that at least a human head will fit within the enclosure 100 and be capable of viewing each of the plurality of light sources 106. In some embodiments, it may also be desirable for the height 146 to be sufficiently large that a human head and a pair of human hands holding a book will fit within the enclosure 100. The height 146 may be, for example, between 30 inches and 60 inches (76.2 centimeters (cm) and 152.4 cm), between 30 inches and 44 inches (76.2 cm and 111.76 cm), about 42 inches (106.68 cm), or the like. Where used in this context, “about” refers to the referenced value plus or minus 10 percent of the referenced value.

The frame 108 (and thus enclosure 100) may have a width 148 from a base of the first sidewall 118 to the base of the second sidewall 120 (when the enclosure 100 is coupled to the bed 104, the width 148 is in a similar direction as a width of the bed 104). It may be desirable for the width 148 to be similar to a width of the bed 104 such that the enclosure 100 is sufficiently wide so as to allow human shoulders (e.g., shoulders of a human child) to comfortably fit within the enclosure 100. The width 148 may be, for example, between 30 inches and 64 inches (76.2 cm and 162.56 cm), between 36 inches and 60 inches (91.44 cm and 152.4 cm), about 48 inches (121.92 cm), or the like, or the like. In some embodiments, the width 148 may remain constant along a length of the enclosure 100 (i.e., the width 148 may have the same distance regardless of where it is measured along a base of the enclosure 100).

The frame 100 (and thus enclosure 100) may have a length 149 from the first end 112 to the second end 116. The length 149 may correspond to a length of the side support bars 129. The length 149 may be sufficiently large that at least a head of a human may comfortably fit within the enclosure 100. The length 149 may be, for example, between 24 inches and 60 inches (60.96 cm and 152.4 cm), between 28 inches and 48 inches (71.12 cm and 121.92 cm), about 36 inches (91.44 cm), or the like. In some embodiments, the length 149 may remain constant along the width 148 of the enclosure 100 (i.e., the length 149 may have the same distance regardless of where it is measured on the enclosure 100).

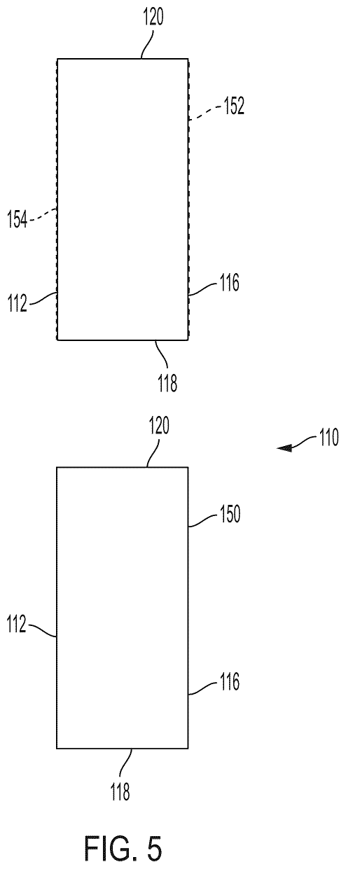

Turning now to FIGS. 1A, 1B, 1C, 2, and 5, the sheet 110 may include multiple layers, plies, or the like. In some embodiments, the layers or plies may be coupled together. For example, the sheet 110 may include a first, or outer, layer 150 and a second, or inner, layer 152. The outer layer 150 may be relatively thick and may function as a blackout sheet. The outer layer 150 may be formed from any material and may be sufficiently thick to reduce an amount of light that may pass therethrough. For example, the outer layer 150 may be formed using polyester, acrylic, nylon, cotton, linen, or the like.

The inner layer 152 may function as a liner and may also function to house the plurality of lights 106. For example, the inner layer 152 may define pockets into which the lights 106 may be housed, the lights 106 may be coupled to the inner layer 152 (e.g., using adhesive or fastener, or sewn thereon), or the like. The inner layer 152 may be formed using any material such as polyester, acrylic, nylon, cotton, linen, or the like.

The inner layer 152 may be coupled to the outer layer 150 using any known technique. For example, the inner layer 152 may be sewn together with the outer layer 150. As another example, fasteners may be used to couple the inner layer 152 to the outer layer 150. In some embodiments, a zipper 154 may be used to couple the inner layer 152 to the outer layer 150. It may be desirable for the inner layer 152 to be removably coupled to the outer layer 150 such that the lights 106 may be accessed and replaced (e.g., if some of the lights 106 become damaged or stop functioning properly).

In some embodiments, the sheet 110 may include separate pieces of sheet that form different portions of the enclosure 100 and are coupled together. In some embodiments, a first piece of sheet may be used to form the first end 112 of the enclosure 100 (e.g., sheet that creates the doors defining the opening 114), a second piece of sheet that forms the second end 116 of the enclosure 100, and a third piece of sheet that comprises the first layer 150 and the second layer 152 that together forms the remainder of the enclosure 100. In that regard, the third piece of sheet may form the first sidewall 118, the second sidewall 120, and the arched top 122. The first piece of sheet (forming the first end 112), the second piece of sheet (forming the second end 116), and the third piece of sheet (forming the sidewalls 118, 120 and arched top 122) may be coupled together using any means such as sewing, fasteners, zippers, or the like. In some embodiments, all of the lights 106 may be coupled to the third piece of sheet (e.g., may be coupled to the inner layer 152 of the third piece of sheet).

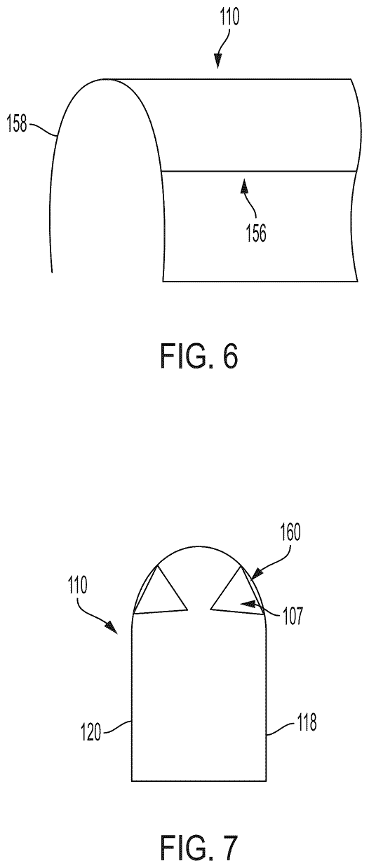

Turning to FIGS. 1A, 1B, 3, 4, and 6, at least one of the sheet 110 or the frame 108 may define or include features that facilitate coupling of the sheet 110 to the frame 108. As shown in the example of FIG. 6, the sheet 110 may define a plurality of sleeves 156. The sleeves may be formed within the sheet 110 or may be formed using additional material coupled to the sheet 110. Each of the sleeves may correspond to one or more of the first plurality of elongated members 124. Some or all of the first plurality of elongated members 124 may have a corresponding sleeve. The elongated members 124 may be positioned within the sleeves 156 at any time, such as before coupling the first plurality of elongated members 124 to the second plurality of elongated members 126. After the elongated members 124 have been positioned within the sleeves 156, the first plurality of elongated members 124 may be coupled to the second plurality of elongated members 126.

In some embodiments, the sheet 110 may also include features that facilitate coupling of the second plurality of elongated members 126 to the sheet 110. For example, the sheet 110 may also include sleeves 158 that correspond to the second plurality of elongated members 126. The second plurality of elongated members 126 may be positioned within the sleeves 158 before coupling to the first plurality of elongated members 124.

In some embodiments, some or all of the sleeves 156, 158 may include openings along a length of the respective sleeve. These openings may provide access to facilitate positioning of a physical connector 128 within the sleeve such that two or more elongated members may be coupled together at the opening using the physical connector 128.

In some embodiments, features other than sleeves may be used to facilitate coupling of the sheet 110 to the frame 108. For example, clips may be coupled to the sheet 110 at locations in which elongated members 124, 126 are to be positioned. In that regard, the frame 108 may be assembled and the sheet 110 may be positioned in place over the frame 108. After positioning the sheet 110 in a desired location relative to the frame 108, the clips may be attached to respective elongated members 124, 126, thus coupling the frame 108 to the sheet 110.

Turning now to FIGS. 1A, 1B, 1C, and 7, the sheet 110 may include or define one or more speaker coupling 160 for coupling one or more speaker 107 to the enclosure 100. The speaker coupling 160 may include any feature or means for coupling a speaker 107 to the enclosure 100. For example, the speaker coupling 160 may include a pocket defined by the sheet 110. In that regard, a speaker 107 may be placed in the pocket before, during, or after assembly of the enclosure 100. In some embodiments, a wire, cable, or other physical connector may be routed from the controller 103 to the pocket. The speaker 107 may be electrically coupled to the physical connector to facilitate electrical communication between the speaker 107 to the controller 103. In some embodiments, the enclosure 100 may lack such physical connectors. In these embodiments, the speaker 107 may be capable of wireless communication (e.g., Bluetooth®, Wi-Fi, or the like) such that the controller 103 and speaker 107 (or the mobile device 115 and the speaker 107) may communicate wirelessly.

In some embodiments, the speaker coupling 160 may include additional or alternative features. For example, the speaker coupling 160 may include a fastener portion (e.g., a snap fit connector) designed to be coupled to a similar fastener portion (e.g., a mating snap fit connector) on a speaker 107. The fastener of the speaker coupling 160 may mate with and couple to the fastener of the speaker 107, thus coupling the two together. As another example, the speaker coupling 160 may include hook or loop features and the speaker 107 may include the other of hook or loop features. In this example, the hooks or loops of the speaker coupling 160 may mate with the hooks or loops of the speaker 107 to couple the speaker 107 to the speaker coupling 160 using mating hook and loop fasteners.

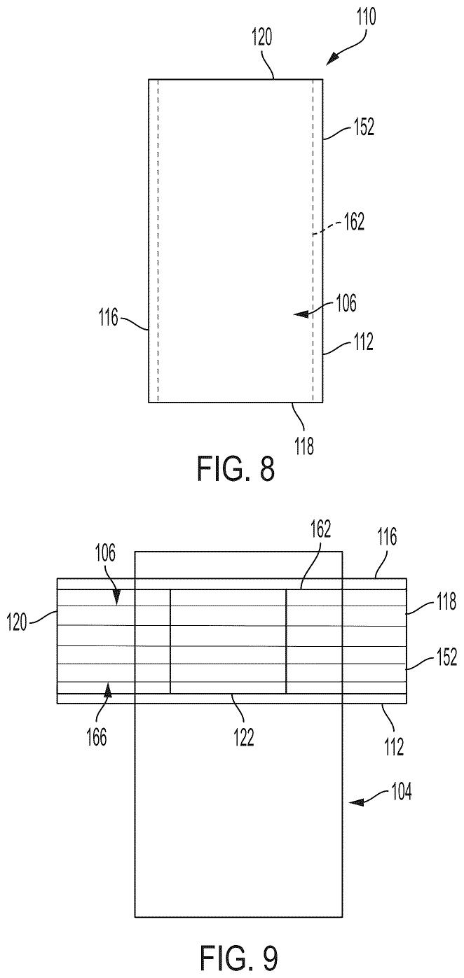

Referring now to FIGS. 1A, 1B, 1C, 8, and 9, additional details of the inner layer 152 of the sheet 110 are shown. As referenced above, the inner layer 152 may be designed to be coupled to the plurality of light sources 106. The light sources 106 may be spread throughout an area of the inner layer 152. That is, the inner layer 152 may define a lighting region 162 throughout which the plurality of light sources 106 are distributed. As shown, the lighting region 162 may extend from the first sidewall 118 to the second sidewall 120, or may at least cover a majority of the distance from the first sidewall 118 to the second sidewall 120. Likewise, the lighting region 162 may extend from the first end 112 to the second end 116, or may at least cover a majority of the distance from the first end 112 to the second end 116. In the example shown in FIGS. 8 and 9, the lighting region 162 extends from the first sidewall 118 to the second sidewall 120, and from an area relatively close to the first end 112 to an area relatively close to the second end 116 (i.e., within a distance of 0.5 inches (12.7 mm), 1 inch (25.4 mm), 3 inches (76.2 mm), or the like of the ends 112, 116). In that regard, the plurality of lights may be distributed across the sidewalls 118, 120 and the arched top 122, and may be distributed over a majority of the surface area of the inner layer 152.

In some embodiments, the plurality of light sources 106 may include LEDs, such as strips of LEDs. FIG. 9 illustrates an example distribution of LED strips 166 throughout the lighting region 162. FIG. 9 also illustrates the positioning of the inner layer 152 and the strips of LEDs 166 relative to the bed 104. The light sources 106 may include multiple strips of LEDs 166, and each of the strips 166 may include multiple individual LEDs. Each individual LED in each of the strips 166 may be individually controlled. That is, each separate LED may be separately controlled to output light of different colors, to output light of different intensities, and to turn on or off in different patterns or at different times.

In some embodiments, the light sources 106 may include between 2 and 20 LED strips 166, between 2 and 10 LED strips 166, between 4 and 6 LED strips 166, or 5 LED strips 166. In some embodiments, each LED strip 166 may include between 25 and 200 individual LEDs, between 50 and 100 individual LEDs, about 75 LEDs, or the like. Where used in this context, “about” refers to the referenced value plus or minus 10 percent of the referenced value. In the example shown in FIG. 9, the plurality of light sources 106 includes 5 LED strips 166, and each LED strip 166 includes about 75 LEDs. The LED strips 166 may be provided in reels and may be cut to a desired length, so each strip may have greater or fewer than 75 individual LEDs.

Each of the LED strips 166 may extend from the first sidewall 118 to the second sidewall 120. That is, each of the LED strips 166 may extend from a bottom of the first sidewall 118 (e.g., where the first sidewall 118 contacts the bed 104), across the first sidewall 118, across the arched top 122, and across the second sidewall 120 to a bottom of the second sidewall 120. Stated differently, each of the LED strips 166 may extend across an entire width of the enclosure 100 (the width extending from the bottom of the first sidewall 118 to the bottom of the second sidewall 120) or close to across the entire width. The LED strips 166 may be spaced along a length of the enclosure 100 from the first end 112 or a location close thereto to the second end 116 or a location close thereto. Stated differently, the strips may be distributed across the entire length of the enclosure 100 (the length extending from the first end 112 to the second end 116) or close to across the entire length. Thus, the plurality of LEDs are distributed across nearly the entire surface area of the inner layer 152 of the enclosure (i.e., across nearly the entirety of the first sidewall 118, the second sidewall 120, and the arched top 122). In some embodiments, additional LED strips 166 (or individual LEDs) may also be located on the material defining at least one of the first end 112 or the second end 116.

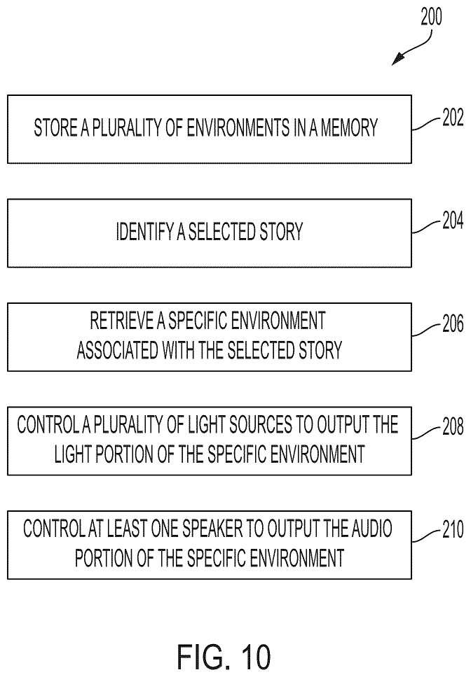

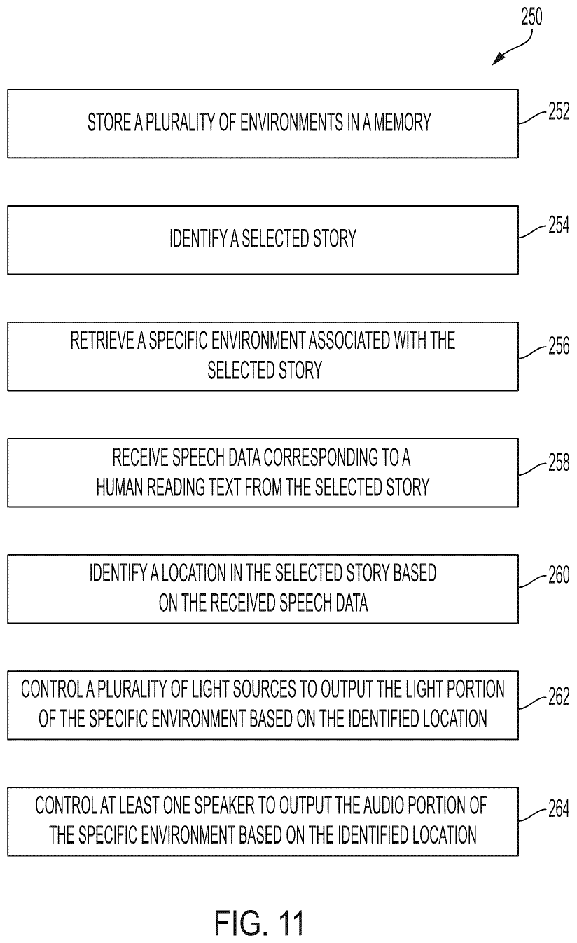

Referring briefly to FIGS. 10 and 11, various methods for providing an immersive storytelling experience within an enclosure (e.g., an enclosure similar to the enclosure 100 of FIGS. 1-9) will be described in detail. The methods may be performed by a system similar to the system 101 of FIGS. 1-9. That is, the methods may be performed by components of a system that are similar to the components of the system 101 that are shown in FIG. 1C (e.g., a controller 103, a memory 105, lights 106, a speaker 107, an input device 109, an output device 111, a network access device 113, and a mobile device 115). The system that performs the methods may be used in conjunction with, or may include, an enclosure similar to the enclosure 100 of FIG. 1A. In that regard, a user may at least partially enter the enclosure and the system may, with or without user input, perform the methods.

Turning now to FIG. 10, a method 200 for providing an immersive storytelling experience within an enclosure is shown. The method may begin in block 202 where a plurality of environments may be stored in a memory. The environments may include instructions for generating light data by a plurality of light sources within the enclosure, and may also include instructions for generating audio data by one or more speaker within the enclosure. Each environment may correspond to a story (such that there is one environment for one story) or may each correspond to a specific atmosphere, event, mood, or other literary element (in which case a single environment may be applied to multiple stories, and each story may be associated with multiple environments). For example, a first environment may correspond to an angry atmosphere and may include rapidly flashing red lights along with sounds of thunder, a second environment may correspond to a suspenseful atmosphere and may include solid red lights along with suspenseful music, and a third environment may correspond to a happy atmosphere and may include flickering white or blue lights along with happy music and chirping birds. In some embodiments, each environment may correspond to one story. In these embodiments, the environment may include or represent multiple atmospheres that follow along a trajectory of the corresponding story. That is, the environment may include happy atmospheres during happy portions of the story and sad atmospheres during sad portions of the story. In embodiments in which one environment corresponds to an entire story, the environment may also include speech data that reads the words of the story aloud. That is, the environment may include speech data of an individual reading the story aloud (similar to an audio book).

The memory in which the environments may be stored may include one or more local memory (i.e., coupled to, located within, or located in proximity to the enclosure), one or more remote memory (i.e., as part of a remote server or cloud server), a memory of a mobile device of a user, or some combination thereof. The memory may be coupled to a local controller or a controller of a mobile device. A local memory may be coupled to the controller via one or more bus or port such as a data or memory bus, a serial port, an Ethernet port, a USB port, a Bluetooth® port, a Wi-Fi port, or the like. In that regard, the local memory may include primary memory (e.g., RAM or ROM) or external memory (e.g., a disk drive). A remote memory may be coupled to the controller via one or more network access device and a network. For example, a Wi-Fi port may communicate with the controller and with a remote server having the remote memory; the Wi-Fi port may facilitate communications between the controller and the memory of the remote server. As another example, the controller of a mobile device may communicate with a remote server having a memory using a network access device.

The environments may be stored in the memory using any one or more known technique. For example, a local memory may be pre-loaded with environments prior to sale to a customer. During assembly of each system, the manufacturer may load the environments onto the local memory such that the environments are already stored in the memory when a user purchases the system. As another example, a user may connect a portable storage device (e.g., a compact disk (CD), a USB key, or the like) having one or more environments stored thereon to an input device (e.g., a CD-ROM drive or a USB port) and may enter instructions that cause the environments to transfer from the portable storage device to the memory. In some embodiments, the portable storage device may function as the memory. As yet another example, a manufacturer or distributor of the systems may load environments into a remote memory and the controller may cause the network access device to communicate with the remote memory, to download the environments, and to transfer the environments to a local memory. As another example, a memory of a mobile device may be programmed with environments during installation of a mobile application (or upon later download request by the user). In some embodiments, the environments may remain on the remote memory and may not transfer to a local memory such that the remote memory is the memory in which the plurality of environments is stored. In these embodiments, the controller may cause the lights and speaker(s) to play the environments directly from the remote memory. In some embodiments, a manufacturer or distributor may force updates to each system that result in pushing the environments to the network access devices of the systems, causing the local memories to store the environments. In some embodiments, these updates may also include updates to operation of the systems (e.g., new firmware or software for at least one of the controller or memory). In some embodiments, the manufacturer or distributor may force updates to the systems that only include updates to operation of the system and lack new environments.

In block 204, the controller may identify a story that is selected by a user. The controller may make this identification in any of several manners. In some embodiments, a user may provide an identification of the selected story using an input device of the enclosure or of a mobile device. For example, an output device may output a list of one or more stories, and the input device may receive user input including a selection of the desired story (e.g., the input device may include a touchscreen, buttons, a keyboard, a mouse, or the like, and the user may use the input device to select the selected story). As another example, the input device may include a keyboard and a user may type an identifier of the selected story. As yet another example, the input device may include a microphone and a user may speak the name of the selected story. As another example, a touchscreen of the mobile device may output a list of stories, and the user may make a story selection by touching the corresponding story on the touchscreen.

In some embodiments, the controller may automatically identify a selected story using any of several known techniques. For example, a user may bring a book into the enclosure, and the enclosure may include a camera as an input device; or the user may point a camera of the mobile device towards the cover of the book. The enclosure camera may detect image data corresponding to an entrance to the enclosure, an area outside of the entrance, or a portion of a volume defined by the enclosure. The controller may analyze the detected image data and may determine an identifier (e.g., a title) of the book that was brought into the enclosure based on the analysis of the image data, and may determine that the book is the selected story based on the determined identifier. In some embodiments, the user may be instructed to face the cover of the book towards a specified camera so the camera can detect the title of the book. As another example, the book may include a radio frequency identification (RFID) tag embedded within or coupled thereto. The enclosure or mobile device may include an RFID reader that detects information stored on the RFID tag as the book is brought at least one of within a predetermined distance of the enclosure or into the enclosure, and the controller may identify the selected story based on the detected information stored on the RFID tag. For example, the RFID tag may include a title of the book. In some embodiments, the RFID tag may include additional information such as audio data or light data corresponding to an environment of the book, and the RFID reader may retrieve this data from the RFID tag. As yet another example, the book may include another storage device and a communication means (e.g., a memory and a Bluetooth® transmitter), and the system may communicate with the communication means included with the book to identify the selected story. As another example, a mobile device (e.g., a tablet, smartphone, laptop, or the like) may have a story downloaded thereon, and the system may communicate with the mobile device. As the user pulls up a book or story, the system may identify the selected story based on the communications with the mobile device. The mobile device may store additional information associated with the book or story such as environment data. In these embodiments, a user may read a story from the mobile device while the system outputs then environment(s) using the lights and speaker(s). As another example, the mobile device may function as an electronic book (e.g., in a similar manner as a Kindle®). The controller (i.e., of the mobile device or of the enclosure) may identify the story in response to the story being pulled up for electronic reading on the mobile device.

In some embodiments, the controller may request confirmation of the selected story from the user regardless of how the selected story is identified. For example, the system may request a verbal “yes” after outputting an identifier of the selected story, or may request a specific input via the input device (e.g., depressing a “confirm” button on a touchscreen) after outputting the identifier.

In block 206, the system (the controller, for example) may retrieve one or more specific environment that is associated with the selected story. The environment(s) may be retrieved from the memory. For example, the environment(s) may be retrieved from a local memory directly by the controller. As another example, the environment(s) may be retrieved from a remote memory (e.g., a cloud memory) by the controller via the network access device. As another example, the environment(s) may be accessed by a controller on a mobile device querying a memory of the mobile device. Where used in this context, “retrieve” may mean to transfer from a local or remote memory to a primary memory (e.g., RAM or ROM), to determine where in a local or primary memory the environment is stored, to transfer from a remote memory to a local memory, or the like. For example, the controller may transmit an identifier of the selected story to the remote memory and may receive the environment and store the environment in a primary memory in response to the transmission. If each environment corresponds to one story then the system may retrieve the environment that corresponds to the selected story. In these embodiments, the environment may also include speech data corresponding to the story that includes one or more voices reading the words of the story aloud.

However, if each environment corresponds to an atmosphere or other similar element then the system may retrieve all environments that correspond to the selected story. For example, a book may include portions that are sad, other portions that are joyful, and yet other portions that are suspenseful. The controller may then retrieve one or more sad environment, one or more joyful environment, and one or more suspenseful environment. In some embodiments, the controller may be informed of the specific environment(s) to download (e.g., sad environment number 14), and in some embodiments the controller may be informed of a general category of the environment (e.g., a sad environment) and the controller may select any of a number of environments within the category. The controller may make a selection from multiple options using any technique such as a random selection, an ordered selection, or the like.

The controller may identify the specific environments that correspond to the book using any known manner. For example, if the book includes an RFID tag then the data stored on the RFID tag may include identifiers of each environment that is to be associated with the story. As another example, a memory may store a list of all potential stories and a list of environments that correspond to each story. The controller may communicate with the memory to identify the environments that correspond to the story. The identifiers of each environment may also include an order of the environments and timing for each environment. For example, the controller may be informed that a specific book is associated with a 10 minute sad environment, then a 20 minute suspenseful environment, and finally a 5 minute happy environment.

In some embodiments, the information used by the controller to identify the corresponding environments (or to identify the selected story) may also include speech data corresponding to the text of the story or an identifier of such speech data. The speech data may include a voice of an individual reading the story aloud in a similar manner as an audio book. For example, the controller may retrieve this speech data from an RFID tag or another storage device located on or coupled to the book.

In some embodiments, the controller may retrieve the speech data from the memory or from another memory when retrieving the specific environments or at another time. For example, when the controller retrieves the environments associated with a story from a memory, the controller may also retrieve the speech data associated with the story. In some embodiments, the environments and speech data associated with a story may be packaged together and retrieved by the controller at one time. In some embodiments, the environments and speech data may be packaged separately. In these embodiments, the controller may retrieve the environments and the speech data simultaneously or separately. For example, the controller may retrieve speech data and identifiers of environments within the story from a remote memory and may retrieve the specific environments from a local memory.

In some embodiments, the controller may also retrieve information regarding locations in the story at which different environments at least one of begin or end. This information may be packaged with the environments, packaged with the speech data, or packaged separately. For example, the controller may retrieve specific book information corresponding to a selected book from a remote memory (e.g., by transmitting an identifier of the book to the remote memory and receiving the book information in response). This specific book information may include speech data for the book, identifiers of environments within the book, and times or locations at which each environment begins. The environment data (i.e., the specific instructions for control of the light sources and the specific audio data that sets the atmosphere) may be stored in a local memory and may or may not require retrieval.

The controller may store any of this retrieved information in a memory such as a local memory coupled to the enclosure, a local memory on a mobile device, a removable local memory, or the like (e.g., solid state memory, random access memory, programmable read-only memory, cache memory, local secondary or external memory, or the like). This is because it may be desirable to be able to access the specific information associated with the story (e.g., environments and speech data) relatively quickly and without interruptions, and interruptions may occur if the information must be accessed remotely during a storytelling experience.

In some embodiments, the input device may receive input from the user indicating that the user is ready for the story to begin. For example, the user may click a “start” button on an interface (e.g., touchscreen or keyboard), may speak a command (e.g., “begin”), may begin reading the book (such that the controller identifies the speech data as corresponding to the first words of the book), or the like. In some embodiments, the controller may begin the storytelling automatically such as after a period of time has elapsed from when the selected story is identified or when all data has been retrieved and stored locally. In some embodiments, the input device may be an input device on a mobile device; in these embodiments, the user may click a “start” button on a mobile application running on the mobile device to cause the story to begin. The story may start by either the input being transmitted to a controller in the enclosure to cause the controller to begin, or a controller on the mobile device receiving the input and beginning to control the lights and speaker of the enclosure remotely based on the input.

In some embodiments, the system may not include or have access to specific environments for a particular story. In these embodiments, the story may include tags that indicate atmospheres at various portions thereof, and the environments may be identified based on atmospheres that they represent. In that regard, the system may retrieve environments that correspond with each atmosphere within the story. For example, the system may learn that the selected story includes happy portions, suspenseful portions, and sad portions. In this example, the system may retrieve any one or more happy environment, any one or more suspenseful environment, and any one or more sad environment. Continuing the example, after downloading a mobile application, a memory of a mobile device may store one or more environment for each of a plurality of atmospheres. The controller may learn the locations of various atmospheres in the story and may select a specific environment to play for each atmosphere in the story.

Once the system is ready to begin the storytelling (e.g., based on user input or automatically) then the method 200 may proceed to blocks 208 and 210. In block 208, the controller may control a plurality of light sources (e.g., LEDs located on each of multiple strips) to output the light portion of the specific environment. In block 210, the controller may control at least one speaker to output the audio portion of the specific environment. In embodiments in which the specific environment corresponds to an entire book or story then the audio portion may include the speech data as well. In embodiments in which multiple environments correspond to a single book or story, the controller may also control the at least one speaker to output the speech data in block 210.

It may be important for the light data and the audio data to be temporally aligned since the light data, the non-speech audio data, and the speech audio data each correspond to specific locations within a story. In that regard, the controller may begin to output the light data and the audio data simultaneously. In this way, when the speech data of a story transitions from a suspenseful atmosphere to a happy atmosphere, the light data changes to happy lighting and the non-speech audio data changes to happy audio (e.g., birds chirping and happy music). In some embodiments, the light data and the audio data may include tags at specific intervals throughout the story. The controller may verify that the timing of the light data and the audio data is aligned at each one of these tags. If the light data and audio data are determined to be mis-timed then the controller may begin outputting the light data and the audio data simultaneously at the next tag (or may return and do so at a previous tag). In some embodiments, the controller may periodically or continuously compare the location of the light data and the audio data to ensure the two are temporally aligned.

In some embodiments, the user may provide input to the system using the input device as the story progresses. For example, the user may be able to provide input to pause the storytelling (e.g., by pressing a “pause” button or speaking a command), in which case the controller will cease outputting the light and audio data until the user provides input to resume the storytelling. Similarly, the user may provide input to stop the storytelling, in which case the light and audio data are ceased and the local memory (e.g., cache) is emptied of the specific data associated with the selected story.

In some embodiments, the user may request a rewind or fast forward of the storytelling. Such a request may include rewinding and fast forwarding at least one of at a specific pace, by a specific time, or to a specific point in the story (e.g., to the previous or next chapter). In some embodiments, the user may select a specific amount of time for a rewind or fast forward, or a location in the story at which to rewind or fast forward to. For example, the user may provide input to rewind or fast forward by a specific amount of time (e.g., 3 minutes) and the system will accommodate such a request. As another example, the user may request a fast forward by a quantity of chapters (e.g., 2 chapters) or to a specific chapter (e.g., to chapter 7), and such request will be accommodated by the system.

In an exemplary situation, an enclosure may include a plurality of light sources and at least one speaker. The enclosure may further include a Bluetooth® receiver designed to receive Bluetooth® wireless signals, and coupled to the light sources and speaker. A user may download a mobile application onto a mobile device. As part of the mobile application, either a memory of the mobile device may store a plurality of environments, or the controller may access a remote memory to retrieve environments. The user may have the ability to select a story using the mobile application, and the mobile application may associate some environments with the story (along with times at which each environment should be output). The user may click a “start” button on the mobile device to initiate playback of the light and audio data. The controller of the mobile device may control the plurality of lights and the speaker to output light and audio data, respectively, via a Bluetooth® signal from the mobile device to the Bluetooth® receiver in the enclosure. At certain times in the story, the controller may switch between environments and may control the lights and speaker accordingly. The user may pause, rewind, fast forward, switch stories, or the like by providing input using the mobile device. In that regard, the system may function properly without any controller or other logic device coupled to or located within the enclosure. Such embodiments may allow for manufacture of a final enclosure product at significantly less cost and in less time than embodiments in which a controller and memory are required in the enclosure.

Referring to FIG. 11, another method 250 for providing an immersive storytelling experience within an enclosure is shown. The method 250 may include similar aspects as the method 200 of FIG. 10. While the method 200 may be used with storytelling environments in which a corresponding system outputs the text of the story as audio data, the method 250 may be designed to enhance a storytelling experience in which a user reads the text of the story aloud. However, the method 200 may be used in conjunction with a user reading the text of the story aloud (both with and without the text of the story being output as audio data), and the method 250 may be used when a user wishes for the text of the story to be output as audio data. Various blocks of the method 250 may be performed in a similar manner as corresponding blocks of the method 200. In that regard, any embodiments discussed above with reference to FIG. 10 may also apply to the method 250 of FIG. 11.

The method 250 may begin in block 252 in which a plurality of environments may be stored in a memory. This block may be performed in a similar manner as in block 202 of FIG. 10. The environments may be stored in any type of memory such as a local memory, a remote memory, a memory on a mobile device, or the like.

In block 254, the system may identify a selected story. The selected story may be identified in a similar manner as in block 204 of FIG. 10. For example, the story may be identified using a camera, based on user input, by reading a RFID tag coupled to a book brought into the enclosure, by a user using an input device on a mobile device, or the like.

In block 256, the system may retrieve one or more specific environment associated with the selected story. This may be performed in a similar manner as in block 206 of FIG. 10. For example, a controller (either coupled to the enclosure or within a mobile device) may identify a location in a local memory in which the environment(s) are stored, may retrieve the environment(s) from a remote memory and store the environment(s) in a local memory, or may access the environment(s) from a removable storage device (e.g., a CD, a USB key), or the like. The information retrieved by the controller may also include information that associates the environments (or portions of an environment) with specific locations in the selected story. This information may associate entire portions of the selected story with a specific environment or portion of an environment (e.g., page 5 paragraph 2 through page 6 paragraph 4 are associated with a sad portion of the selected environment). This information may also or instead associate specific locations in the story with transitions between environments or portions thereof (using the example above, at the end of page 5 paragraph 1 the sad portion of the environment is to begin playing). The portions of the story that are associated with the environments or portions thereof may be identified by page numbers, paragraph numbers, word count, certain strings of text (e.g., 25 characters, a string of 5 words, etc.), or the like.

In some embodiments, a system that is performing the method 250 may include a microphone which may be coupled to the controller. The microphone may include any microphone that is capable of detecting audio data, such as speech of a user. In some embodiments, the microphone may be coupled to the enclosure or otherwise located in the enclosure. In some embodiments, the microphone may be coupled to the speaker and thus coupled to the enclosure via a coupling between the speaker and the enclosure. In some embodiments, a user may wear the microphone. In some embodiments, the microphone may be included as an input device of a mobile device (e.g., a smartphone) that is used with the enclosure.

In block 258, the microphone may detect speech data corresponding to a human reading text from the selected story. The microphone may transfer the speech data to the controller, which in turn receives the speech data. In some embodiments, the controller may convert the speech data into text (e.g., using a voice-to-text algorithm) or another form of digital information that is interpretable by the controller. In some embodiments, the microphone may continuously detect the audio data. In some embodiments, the microphone may periodically detect the audio data (e.g., every 15 seconds, every 1 minute, every 5 minutes, or the like). In some embodiments, the microphone may randomly detect the audio data. In embodiments in which the microphone continuously detects the audio data, the controller may break the audio data into smaller portions of audio data (e.g., a 5 second portion, a 15 second portion, or the like) and may perform functions using the smaller portions of audio data. In some embodiments, the controller may analyze all of the portions, may select periodic portions to analyze (e.g., may analyze a 15 second portion every 1 minute), may randomly select periodic portions to analyze, or the like.

In some embodiments, the human speech may include instructions before or after the text from the selected story. For example, the instructions may include any instructions for controlling the system. For example, the instructions may include an instruction to stop the immersive storytelling, to pause the immersive storytelling, to fast forward or rewind the immersive storytelling, or the like. The controller may interpret this speech data to determine the requested action, and may then cause the requested action to occur.

In block 260, the controller may identify a current location in the selected story based on the received speech data. The controller may use this information, as discussed below, to control the environment(s) such that the light and audio data correspond to the portion of the story which the user is reading. For example, the controller may identify the spoken words (e.g., using a speech-to-text algorithm) and may compare the identified words to the identified story and determine that the location in the story is immediately following the location of the identified words. In some embodiments, the controller may compare each spoken word to words in the text such that it is constantly aware of the specific location in the story which the user is currently reading. In some embodiments, the controller may attempt to compare the identified words to the entire text of the story. This may provide benefits such as accommodating a user that jumps between chapters or locations within a book. In some embodiments, the controller may only compare the identified words to locations within the book that are relatively close (e.g., within 1,000 words, within 3 paragraphs, within 3 pages, or the like) to the previously-identified location in the selected story. Reducing the amount of text to which the controller compares the identified words may advantageously increase the speed of identifying the location in the selected story.

In block 262, the controller may control a plurality of light sources to output the light portion of the specific environment based on the identified location. In block 264, the system may control at least one speaker to output the audio portion of the specific environment based on the identified location. Blocks 262 and 264 may be performed in a similar manner as in blocks 208 and 210 of FIG. 10. That is, the light data and the audio data may be output in a similar manner as descried above with reference to FIG. 10. For example, a controller of the mobile device may wirelessly control lights and a speaker within an enclosure using a Bluetooth® communication protocol and a receiver coupled to the enclosure.

In some embodiments, the audio data may also include speech data such that the system outputs a spoken version of the words of the story along with the user. This may assist the user in pronunciation if the user is learning to read or if complex words are present in the story. In some embodiments, the controller may control the speaker to only output a spoken version of part of the text upon a prompt from the user. For example, the user may speak a request such as “how do you pronounce the next word” or “help with the next sentence,” and the controller may output a spoken version of the next word or sentence. In some embodiments, the controller may identify when the user mispronounces a word and may output a spoken version of the word to correct the user.

Because the environments or portions thereof are meant to align with certain portions of the story (e.g., happy light and audio data during happy portions of the story), it may be desirable for the light data and audio data to be aligned with the portion of the story which the user is reading. In that regard, the controller may continuously or periodically identify the current location of the story, especially when the user is speaking a portion of the story that is relatively close to a transition point (e.g., when the atmosphere of the story changes from suspenseful to happy). The controller may place more importance on identifying the current location at these transition points to ensure the timing of the change in light data and audio data are aligned with the user's reading of the story. In addition, the controller may periodically or continuously compare the light data and the audio data to ensure that both are outputting the same environment or portion thereof, and that transitions of the light sources occur simultaneously with transitions of the speaker(s).

In some embodiments, if the controller identifies that the user has stopped reading, the controller may stop all light and audio outputs of the environment (i.e., control the light sources and the speaker to cease outputting any light or audio data, respectively). In some embodiments, the controller may stop all light and audio outputs if the user stops reading for a sufficient period of time (e.g., 3 seconds, 5 seconds, 30 seconds, 1 minute, etc.). For example, if the controller fails to receive speech data from the microphone, the controller may stop all light and audio outputs if user speech fails to commence within 30 seconds. In some embodiments, the controller may cause the light sources and speaker(s) to continue outputting light and audio data, respectively, from the last environment or portion thereof that the user read. For example, if the user stops reading during a happy portion of the story then the controller may control the light sources and the speaker to continue outputting happy light data and happy audio data. In some embodiments, the controller may continue this output until at least one of the user resumes speaking or the user provides instructions to the controller to the contrary (e.g., pauses playback).

As an example, an enclosure may include a plurality of light sources and at least one speaker. The enclosure may further include a Bluetooth® receiver designed to receive Bluetooth® wireless signals, and coupled to the light sources and speaker. A user may download a mobile application onto a mobile device. As part of the mobile application, either a memory of the mobile device may store a plurality of environments, or the controller may access a remote memory to retrieve environments. The user may have the ability to select a story using the mobile application, and the mobile application may associate some environments with the story (along with times at which each environment should be output). A microphone of the mobile device may detect speech data of the user as the user reads the book. The controller of the mobile device may identify a story that is being read based on the speech data, and may also identify a location within the story that is presently being read. The controller may wirelessly control lights and a speaker within the enclosure to output an environment that corresponds to the present portion that is being read. As the controller detects the user reading different portions of the story, the controller may change the environments that it controls the lights and speaker to output.

Where used throughout the specification and the claims, “at least one of A or B” includes “A” only, “B” only, or “A and B.” Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A method for providing an immersive storytelling experience within an enclosure, the method comprising:
identifying, by a controller, a selected story;
retrieving, by the controller, a specific environment associated with the selected story, the specific environment including lighting information and audio information each corresponding to the selected story;
controlling, by the controller, a plurality of light sources within the enclosure to output the retrieved lighting information corresponding to the selected story; and
controlling, by the controller, at least one speaker to output the retrieved audio information corresponding to the selected story.

2. The method of claim 1, further comprising detecting, by a radio frequency identification (RFID) reader, a RFID tag associated with the selected story in response to the RFID tag being located in or near the enclosure, wherein identifying the selected story is performed in response to detecting the RFID tag.

3. The method of claim 2, wherein the RFID tag is coupled to or enclosed within a printed version of the selected story such that the identifying the selected story is performed in response to the printed version of the selected story being brought in or near the enclosure.

4. The method of claim 1, further comprising receiving, by an input device, an identifier of the selected story, wherein identifying the selected story is based on the received identifier of the selected story.

5. The method of claim 1, wherein controlling the plurality of lights includes at least one of:
controlling at least a first light to illuminate while at least a second light is turned off;
changing an intensity of light output by at least one of the plurality of lights; or
changing a color of light output by at least one of the plurality of lights.

6. The method of claim 5, wherein controlling the plurality of lights includes each of:
controlling at least the first light to illuminate while at least the second light is turned off;
changing the intensity of the light output by at least one of the plurality of lights; and
changing the color of the light output by at least one of the plurality of lights.

7. The method of claim 1, further comprising storing, in a memory, a plurality of environments including the specific environment, wherein retrieving the specific environment includes retrieving the specific environment from the memory using an identifier of the selected story.

8. The method of claim 1, wherein retrieving the specific environment includes:
transmitting, by a network access device, an identifier of the selected story to a remote server; and
receiving, by the network access device, the specific environment from the remote server in response to transmitting the identifier of the selected story to the remote server.

9. The method of claim 1, wherein the retrieved audio information includes at least one of:
sound effects corresponding to the selected story; or
a spoken version of text of the selected story.

10. The method of claim 1, wherein the controller is located on a mobile device such that controlling the plurality of light sources and the at least one speaker includes transmitting a wireless control signal to a wireless receiver coupled to the plurality of light sources and the at least one speaker.

11. The method of claim 1, wherein:
the retrieved audio information includes a spoken version of text of the selected story; and
the retrieved lighting information causes the plurality of light sources to output light that visually represents features of the text of the selected story such that timing of the light that is output by the plurality of light sources is temporally aligned with timing of the spoken version of the text of the selected story.

12. The method of claim 11, wherein the retrieved audio information further includes sound effects corresponding to the selected story such that timing of the sound effects is temporally aligned with the timing of the spoken version of the text of the selected story and the timing of the light that is output by the plurality of light sources.

13. The method of claim 1, further comprising:
receiving, by a microphone, speech data corresponding to a human reading text from the selected story; and
identifying, by the controller, a location in the selected story based on the received speech data,
wherein:
the retrieved audio information includes sound effects corresponding to the selected story,
the retrieved lighting information causes the plurality of light sources to output light that visually represents features of the text of the selected story, and
controlling the plurality of light sources within the enclosure to output the retrieved lighting information and controlling the at least one speaker to output the retrieved audio information is performed based on the identified location in the selected story such that timing of the sound effects and timing of the light that is output by the plurality of light sources is temporally aligned with the location in the selected story.

14. A method for providing an immersive storytelling experience within an enclosure, the method comprising:
identifying, by a controller, a selected story;
retrieving, by the controller, a specific environment associated with the selected story, the specific environment including lighting information corresponding to light output that visually represents features of text of the selected story and audio information including sound effects corresponding to the selected story;
controlling, by the controller, a plurality of light sources within the enclosure to output the retrieved lighting information such that timing of the light that is output by the plurality of light sources is temporally aligned with timing of the text of the selected story; and
controlling, by the controller, at least one speaker to output the retrieved audio information corresponding to the selected story such that timing of the sound effects is temporally aligned with the timing of the text of the selected story.

15. The method of claim 14, wherein the audio information further includes a spoken version of the text of the selected story, and wherein the timing of the spoken version of the text is temporally aligned with the light that is output by the plurality of light sources and the sound effects output by the at least one speaker.

16. The method of claim 14, further comprising detecting, by a radio frequency identification (RFID) reader, a RFID tag associated with the selected story in response to the RFID tag being located in or near the enclosure, wherein identifying the selected story is performed in response to detecting the RFID tag.

17. The method of claim 16, wherein the RFID tag is coupled to or enclosed within a printed version of the selected story such that the identifying the selected story is performed in response to the printed version of the selected story being brought in or near the enclosure.

18. The method of claim 14, wherein controlling the plurality of lights includes at least one of:
controlling at least a first light to illuminate while at least a second light is turned off;
changing an intensity of light output by at least one of the plurality of lights; or
changing a color of light output by at least one of the plurality of lights.

19. A method for providing an immersive storytelling experience within an enclosure, the method comprising:
detecting, by a radio frequency identification (RFID) reader, a RFID tag associated with a selected story in response to the RFID tag being located in or near the enclosure,
identifying, by a controller, the selected story in response to the detecting of the RFID tag;
retrieving, by the controller, a specific environment associated with the selected story, the specific environment including lighting information corresponding to light output that visually represents features of text of the selected story and audio information including a spoken version of the text of the selected story and sound effects corresponding to the selected story;
controlling, by the controller, a plurality of light sources within the enclosure to output the retrieved lighting information such that timing of the light that is output by the plurality of light sources is temporally aligned with timing of the spoken version of the text of the selected story; and
controlling, by the controller, at least one speaker to output the retrieved audio information corresponding to the selected story such that timing of the sound effects is temporally aligned with the timing of the spoken version of the text of the selected story.

20. The method of claim 19, wherein controlling the plurality of lights includes at least one of:
controlling at least a first light to illuminate while at least a second light is turned off;
changing an intensity of light output by at least one of the plurality of lights; or
changing a color of light output by at least one of the plurality of lights.
